(19) United States
(12) Patent Application Publication
(10) Pub. No.: US 2007/0215699 A1
(43) Pub. Date: Sep. 20, 2007

(54) Method and apparatus for customization and dispensing customized plastic cards

(75) Inventors: John Arego, Sandy, UT (US); Keith Guevara, Salt Lake City, UT (US); Christopher McGee, Draper, UT (US); Jared Smart, Draper, UT (US); Bret Warnick, Draper, UT (US); Dave Boswell, West Bountiful, UT (US)

Correspondence Address: REED SMITH, LLP, TWO EMBARCADERO CENTER, SUITE 2000, SAN FRANCISCO, CA, 94111, US

(73) Assignee: NBO Systems, Inc.

(21) Appl. No.: 11/717,974

(22) Filed: Mar. 14, 2007

Related U.S. Application Data
(60) Provisional application No. 60/783,660, filed on Mar. 17, 2006.

(51) Int. Cl. G06K 5/00; G06F 7/08

(52) U.S. Cl. 235/380; 235/381

(57) ABSTRACT

An apparatus and method for selecting and processing text or images and applying the text or images to a variety of plastic cards. This system allows a user to select or upload images, select or type text and apply the image to either a dispensed plastic card similar in size to a standard credit or gift card. The system can restrict placement of images and text to pre-specified areas of a card based upon the card selected. The method can be used on the Internet to select images and text to apply to card products being purchased. The system can restrict fonts, size and colors based upon the card selected.

This application claims the benefit of U.S. Provisional Application No. 60/783,660, filed Mar. 17, 2006, the disclosure of which is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates generally to customizable cards, and more particularly to a method and apparatus for customization and dispensing of customized cards.

2. Description of the Related Art

Gift cards, debit cards and other similar forms of stored value cards have become very popular, especially for gifts. However, a purchaser usually has a limited selection of cards, and may not be able to find a suitable card at a local store.

### SUMMARY OF THE INVENTION

In one embodiment, the present invention is a process for selecting and processing text or images to a variety of plastic cards. This system allows a user to select or upload images, select or type text and apply the image to either a dispensed PVC card similar in size to a standard credit or gift card. Alternatively a user may use the process to apply text and or images to a personal card using the same system or a modified version of the same system. The process can restrict placement of images and text to pre-specified areas of a card based upon the card selected. The method can be used on the Internet to select images and text to apply to card products being purchased. The system can restrict fonts, size and colors based upon the card selected.

The system may be resident on machines distributed for use by merchants or directly by customers, for example in shopping malls, at customer service areas at merchant locations and in free-standing machines such as kiosks. This system may also be resident on machines at plastic card manufacturing, personalization, fulfillment or distribution centers. In these instances, images may be provided by individuals such as clients and customers, or by corporate or organizational clients. Single customized plastic card orders may contain:
one image, object, or photo with accompanying text;
one image, object, or photo without accompanying text;
multiple images, objects or photos per plastic card ordered with accompanying text;
multiple images, objects or photos per plastic card ordered without accompanying text;
text only

According to a method of the present invention, the customer or client is provided with the functionality to place, resize, and otherwise modify their uploaded image, object, photo, and/or text as it will be printed on the plastic card. This includes the availability of various text fonts, background colors, font colors, font sizes, scripts, etc. This utility allows the image, photo, and/or text to be printed on the front or back of the plastic card, and on a blank or pre-printed area on the plastic card.

In another embodiment, the present invention is configured such that the system may “read” the image when the card is inserted and rather than wait for a user to select the card, automatically apply the restrictions of text and image placement based upon the card inserted into the machine. The system will create a digital image based upon the card inserted. The system will attempt to identify the card using computer vision methodologies.

Another mechanism for interpreting the type of card inserted in this application is to read the data from the magnetic strip (magstripe) and compare to contents to “known” information about the contents of the magstripe. For instance, the first 6-16 digits could be used as needed to determine the card producer. Alternatively, another portion of the magstripe may contain the interpretable data such as the merchant name.

The present invention is embodied, for example, as a device, such as a kiosk, having a user interface and card acceptor/dispenser. Various processes and/or methods of the present invention as described above or elsewhere herein may be performed over the Internet where users access or log into a web page that is a user interface to the process/method of the present invention.

Portions of any devices and processes/methods of the present invention may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a drawing of kiosk located in a mall according to an embodiment of the present invention;

FIG. 2 is a block diagram of a kiosk device according to an embodiment of the present invention;

FIG. 3 is a drawing of exemplary Card and Logo Restriction/Restricted Areas on Gift Cards and a database structure according to embodiments of the present invention;

FIG. 4 is a flow chart of a process for application of logos to a stored value card according to an embodiment of the present invention;

FIG. 5 is a flow chart of a process for applying images and/or text to a user's card according to an embodiment of the present invention; and

FIG. 6 is a flow chart of a process for uploading and applying images, objects, photos, and/or text to plastic cards according to an embodiment of the present invention.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

As described herein, the present invention is applicable to “plastic cards” or “payment cards” which may include, for example, blank cards, partially pre-printed cards, and fully printed cards, all of which may include magnetic stripe cards, credit cards, debit cards, prepaid cards, calling cards, charge cards, gift and loyalty cards, contact-less cards, hotel key cards, retail cards, RFID cards, chip cards, driver's licenses, identification cards and badges, access control cards, commercial cards and transit cards. Therefore, it is understood that all these types of cards, and any similar type of payment cards, are included within the scope of the present invention. Furthermore, the card itself does not necessarily need to be plastic, but may comprise any material suitable for printing on and/or storing information related to a card value, such as a bar code, key number, memory or ID chip, etc.

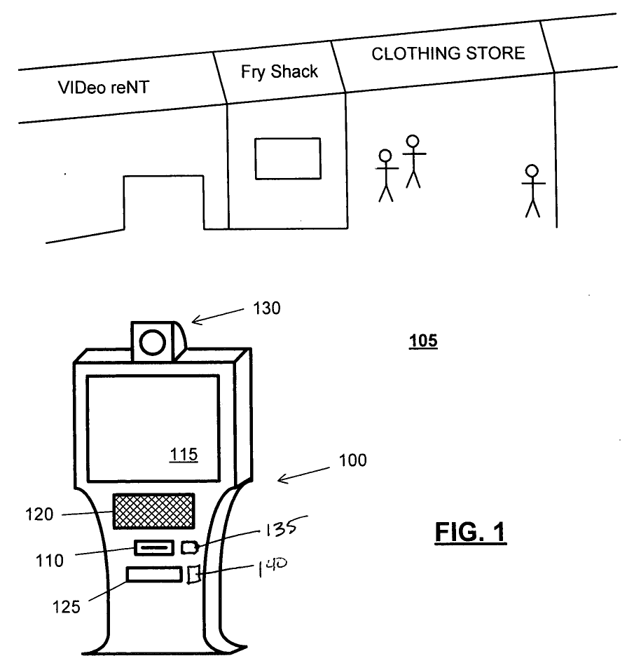

Referring now to the drawings, wherein like reference numerals designate identical or corresponding parts, and more particularly to FIG. 1 thereof, there is illustrated a drawing of a kiosk 100 located in a mall 105 according to an embodiment of the present invention. The kiosk is preferably located at a central location in the mall. The kiosk 100 is, for example, a stand alone unit having a card acceptor 110, and a user interface comprising, for example, a display screen 115. The display screen is, for example a touch sensitive screen that receives user input from a customer touching the screen. Alternatively, or in conjunction therewith, the kiosk includes a keyboard, trackball, joystick, or other devices 120 for receipt of user inputs.

The kiosk 100 is programmed according to one or more of the various embodiments separately described herein. For example, in one embodiment, the kiosk 100 is programmed to accept a value card from one of a plurality of retailers and then retrieve user inputs that direct the customization of the accepted value cards. The customization includes, for example, the printing of text, graphics, and/or photos on the value card.

The plurality of retailers may include any one or more of, for example, any number of independent stores that have their own value cards, all of the retailers or merchants in a mall (mall card), a group of stores owned by a same company (e.g., Gap™ family of stores), and/or a group of independently owned stores that have banded together.

The kiosk 100 also includes, for example, a card dispensing slot 125 for return of the customized value card to the customer/user, and a payment insert device (e.g., credit card reader). The user interface may also be programmed to accept various account information to secure payment. For example, the user interface may accept award confirmation numbers, checking/credit card account numbers, or other accounts to which the kiosk may bill for services requested by the user.

In one embodiment, a camera 130 is included in the kiosk. Programming of the kiosk is configured to take periodic time stamped photos for security purposes. The camera 130 may also be used to take pictures of a user for later printing on a selected card. The camera 130 is shown prominently and conspicuously mounted on the kiosk, but may also be inconspicuously integrated into the overall structure of the kiosk.

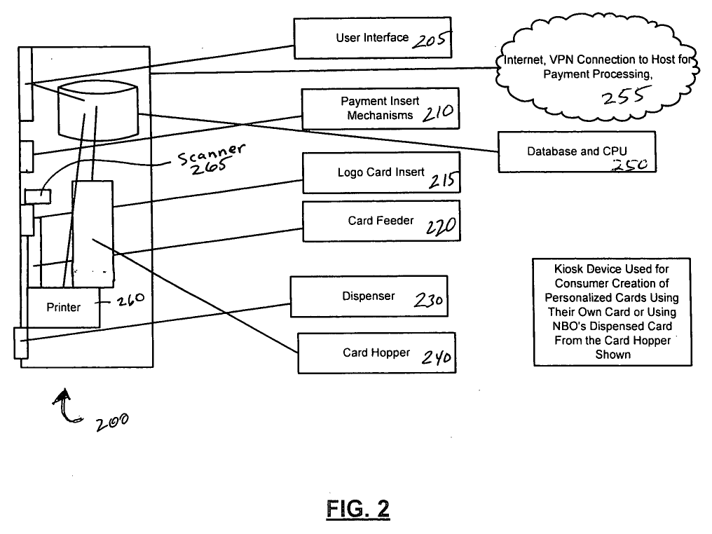

FIG. 2 is a block diagram of a kiosk device 200 according to an embodiment of the present invention. The kiosk 200 includes a user interface 205, a payment insert mechanism 210, a logo card insert 215, a card feeder 220, dispenser 230, and a card hopper 240. A database and CPU 250 provide programming, control, and communications as needed between the various hardware components of the kiosk, including, for example, the user interface 205, payment insert mechanisms 210, card hopper 240, a printer 260, and dispenser 230. As will be described in more detail below, the database contains, for example, information about permissible user customizable areas of various cards inserted into the kiosk and graphics and other information (and their corresponding placements) to be included on the various cards. The database may also include a store of graphics, famous quotes, photos, or other items that may be selected by the consumer/user to include on the customized gift card.

The printer 260 is, for example, a high resolution card printer capable of printing high resolution full color graphics, photos, and text on plastic cards (e.g., value cards, or credit card type cards). A Virtual Private Network (VPN) or other type of electronic communication connection (e.g., Internet, VPN, host-to-host, Ethernet, etc.) may also be utilized for communications between the machine and other electronic devices according to programming and operation of the kiosk 200. The electronic connection may also be presented to the consumer/user through the user interface for web surfing to find or download certain images for inclusion on the customized gift card.

In several embodiments, the kiosk is programmed to accept payment from a consumer via the user interface 205 and payment insert mechanisms 210, and then load, print, and dispense a gift card of the consumer's choice. The hopper provides a gift card that will be printed on. The provided card is, for example, embossed with a card number and expiration (e.g., expiration date). The card also may or may not be pre-printed with a theme. Preferably, the card will not have any logos pre-applied.

The card's magstripe is read and a value is associated with the card in the database. Either in real-time or in a batched process, the card number and value are then populated in a system designed for redemption. This redemption system may reside anywhere (e.g. in communication with kiosk, for example, via secure Internet connection or VPN coupled with the kiosk), but is accessible for authorizations by merchant Point of Sale Systems (POS). These POS systems may be utilized for authorization in the same manner as other debit and credit cards. Alternatively, transactions may be routed separately to a separate system for authorization. The value associated with the card is, for example, of the consumer selected denomination which is then charged to the consumer (e.g., via credit card).

In addition, the plastic card of choice may also be customized by the addition of photos, graphics and text also chosen and provided by the consumer. As noted above, such additional items may be selected from the database or downloaded from a remote location. In another embodiment, electronic interfaces 140 are included on the kiosk and may include, for example, USB connections, memory card readers, IR connections, and RF connections (e.g., 802.11a/b/g, etc). The electronic interfaces may be utilized to input photos, graphics, or text (all generally referred to herein as “graphics”) from compatible devices in which the user has stored such data. The user can then select a desired graphic from the uploaded data.

As noted above, there are various processes that may be performed or programmed into the kiosk. For example, one process performed by the kiosk or mechanism is as follows:

### Step 1: The user approaches an interactive touch screen kiosk.

Steps 2 through 5 may be applied in any order:

### Step 2: The user accesses a help button to view a list of instructions for using the service.

### Step 3: The user inserts any plastic card into a “card” acceptor.

### Step 4: The user puts in a payment code or direct payment using cash, check, credit card, debit card or other payment instrument to pay for application of text or images into the machine.

### Step 5: The user inserts a standard digital storage device into an appropriate interface device.

### Steps 6 through 8 follow step 5:

### Step 6: The user's images are displayed.

### Step 7: The user selects an image to put onto the card.

### Step 8: The user moves the image to the appropriate location where the image will be applied to the card.

Step 8a: The user selects the type of card from a list and a generic image of the card is displayed on the screen. The location for the image is restricted to a maximum size based upon the placement area selected.

### Step 8b: The user is selects and is shown a generic card image and is allowed to put the image anywhere on the card.

Step 9: The user waits for the system to eject the card. The user removes their personalized card from the ejector slot or the drop tray.

In one embodiment, instead of uploading an image, a user can select font, color and size of text to place on the card. Using a manual keyboard or a touch screen keyboard the user crafts the desired message. The same rules are applied based on 8a or 8b.

Another option is to have a hopper(s) with a stack of cards (embossed or non-embossed) that the user can purchase and personalize using any of the methods described previously.

According to the present invention, the customer or client is provided with the functionality to place, resize, and otherwise modify their uploaded image, object, photo, and/or text as it will be printed on the plastic card. This includes the availability of various text fonts, background colors, font colors, font sizes, scripts, etc. This utility allows the image, photo, and/or text to be printed on the front or back of the plastic card, and on a blank or pre-printed area on the plastic card.

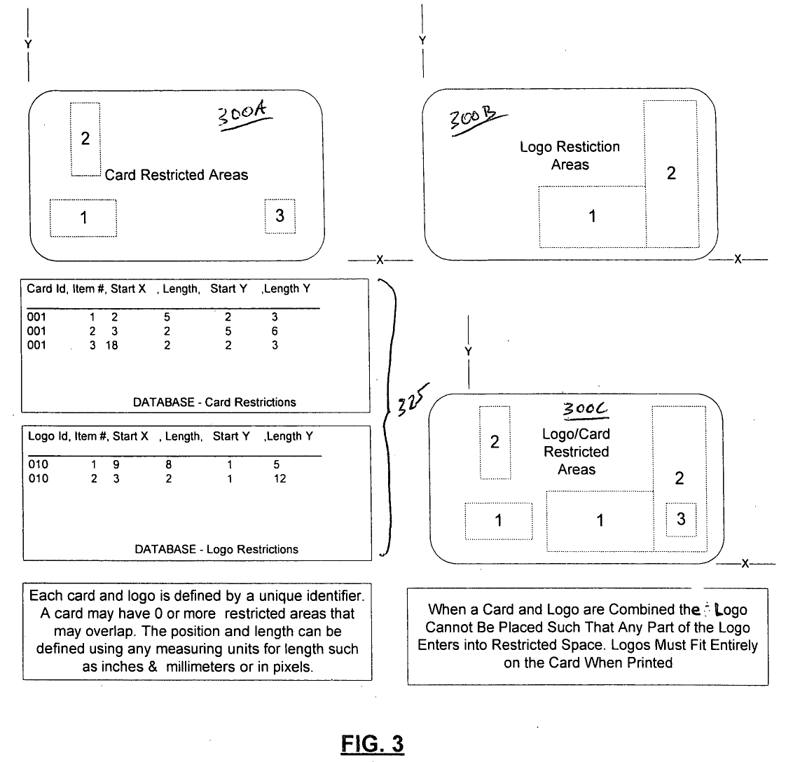

FIG. 3 is a drawing of exemplary Card and Logo Restriction/Restricted Areas on Gift Cards and a database structure according to embodiments of the present invention. A card 300 (A, B, and C) is shown in an x y coordinate system used to identify specific areas on the card. Any type of coordinate or area designation systems may be utilized so long as they, within a reasonable amount of precision, identify the specific areas. The specific areas are, for example, Card restriction areas 300A, Logo restriction areas 300B, and combined Logo/Card restriction areas 300C.

A database 325 provides an example of a computer readable identification of the restricted areas. The database fields include, for example, Logo ID, Item#, and appropriate coordinate system designations (e.g., X Start, X length, Y start, and Y length). Different tables are shown for Card restricted areas and logo restricted areas. Other databases or tables according to the present invention include graphics databases for the inclusion of retailer, mall, and association logos. Such additional data is also accessible by a processor or other control device of the kiosk and used in printing customized or customizable gift cards.

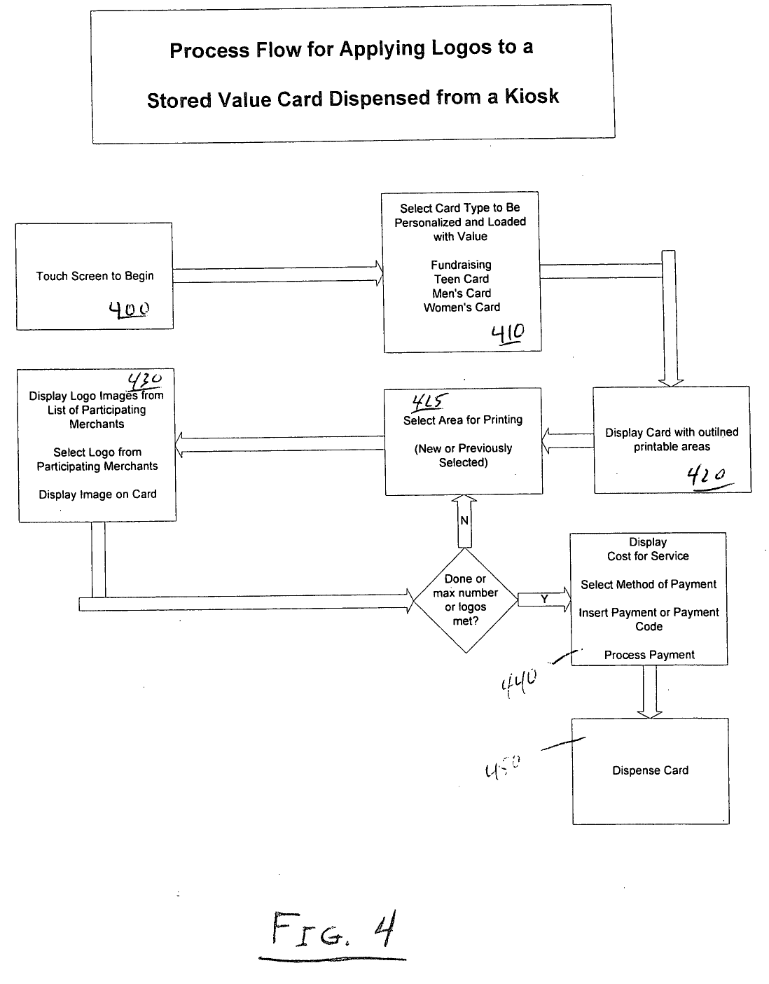

FIG. 4 is a flow chart of a process for application of logos to a stored value card according to an embodiment of the present invention. At step 400, a consumer/user approaches the kiosk and, for example, touches the screen to initiate a value/gift card transaction. The user is presented with a screen that requests selection of the desired card to be purchased. Options for purchasing may include, for example, mall cards, specific retailer cards, fundraising cards, or any number of a host of specific cards that may be offered by retailers and/or other organizations.

At step 410, the user makes the card selection. The kiosk responds by displaying a card to be customized (step 420). The displayed card is an approximate image of the same proportions of the actual card to be dispensed with guidelines that identify areas on the card that can be customized with graphics.

The user interface includes a number of tools to assist the user in selecting and placing graphics and other data on the card. The user interface includes, for example, a button or other mechanism to invoke a search of a graphics database maintained on the kiosk. The user interface may include, for example, a button or other mechanism to invoke a search of a graphics database maintained on the kiosk. The user interface may include, for example, a button or other mechanism to invoke a search for material from the Internet. The user interface may include, for example, a button or other mechanism to invoke instructions for accessing photos, graphics and other material from external sources such as computers, cameras, storage cards, iPods, and other devices via physical or wireless connections available on the kiosk to outside devices.

Regardless of where the customization materials are selected, the user identifies those materials and they are placed on the card in a non-restricted area. The user interface provides tools, such as a trackball, up/down keys, or the touch screen that allow the user to move selected material to any of the unrestricted areas on the card. The user interface includes facilities to allow the user to enter a text message or other greeting on the card.

The user may also select areas for printing logos that, for example, identify retail outlets where the card may be utilized (see step 425). The kiosk responds by displaying available logo images. The logo images are, for example, logos from participating merchants (step 430). The selected logos are then displayed on the card.

Once all the logos and graphics are in place on the displayed card, the transaction is finalized. Finalization includes, for example, a display indicating the total cost for the card & customization, selection of a payment method, and processing of the payment (Step 440). Upon payment, the card is printed and dispensed to the consumer/user (Step 450). Printing and dispensing the card includes, for example, a command issued from the CPU to the card hopper to release a card of the appropriate value (or load a specific value on an unloaded card—e.g., a magnetic strip writer); sending it to the printer, and instructions sent to the printer to print the user select graphical arrangement and logos onto the card at the appropriate locations. The appropriate locations for the logos are, for example, those approved by the logo's merchant as embodied in the previously described restricted areas.

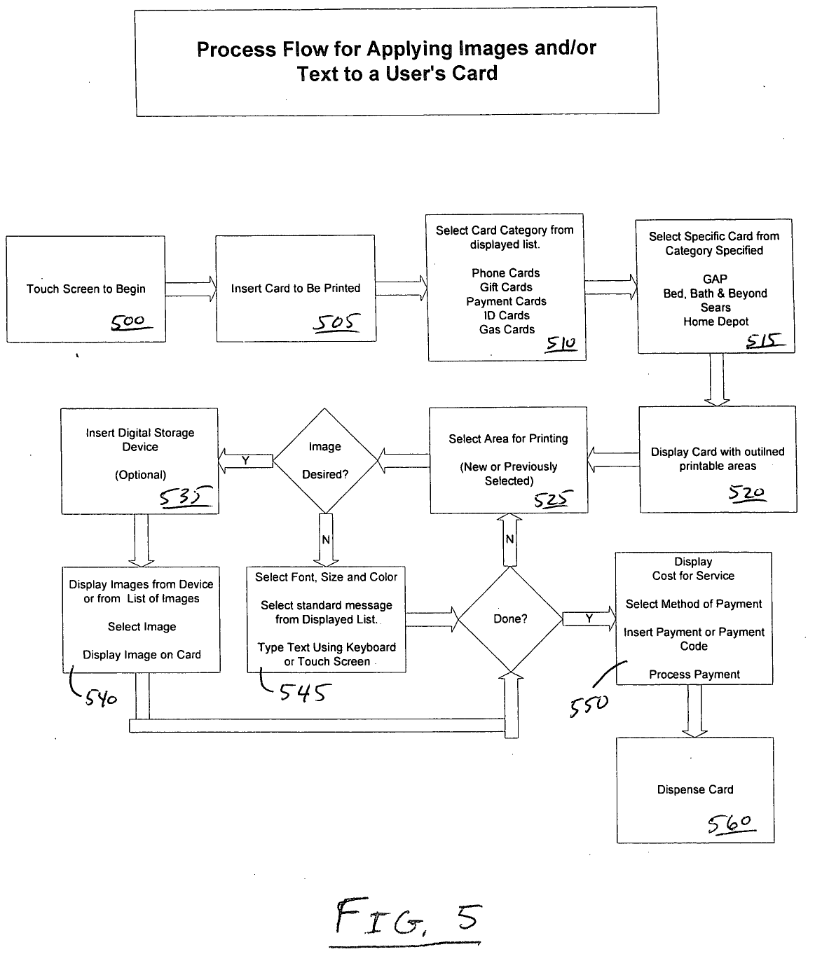

FIG. 5 is a flow chart of a process for applying images and/or text to a user's card. The process begins when a user/consumer touches the kiosk screen (step 500) or inserts a card to be customized.

The card is retrieved by the kiosk (step 505). The card is read to determine any base values or merchants associated with the card. Alternatively, the user selects a general card category (step 510), and then selects from a specific card within the selected general category (step 515).

A display of the card to be printed is provided, with, for example, outlined printable areas (step 520). The displayed card is, for example, a scan of the card submitted by the user. When the user inserts their card into the kiosk, a scanner 265 takes the picture (scans) the card and puts it on the screen. This device may or may not be the same device used to feed the card to the printer.

The user selects a particular printable area (step 525), then selects a desired image (steps 535 and 540). The selection may be made from any of the sources available (database graphics, Internet, external sources, etc.). Similarly, the user may also select the same or different areas for inserting text (step 545). The steps may be repeated until all areas and text and/or graphics as desired by the consumer/user. The process for customization may have a limited time duration to keep consumers from working for extended periods of time.

In one embodiment, the CPU is programmed to assist the consumer user in laying out the customized card. In this embodiment, the user selects the desired graphics and text, and the programming on the CPU selects likely positions for the graphics and text. The user can then up/down arrow through various possible arrangements of the selected graphics.

Once all the logos and graphics are in place on the displayed card, the transaction is finalized. Finalization includes, for example, a display indicating the total cost for the card & customization, selection of a payment method, and processing of the payment (Step 550). Upon payment, the card is printed and dispensed to the consumer/user (Step 560). Printing and dispensing the card includes, for example, a command issued from the CPU to the scanner or cad feeder to release the user inserted card and send it to the printer. In other embodiments, the CPU command is to the card hopper to release a card sending it to the printer. The CPU also sends instructions sent to the printer to print the user select graphical arrangement and logos onto the card at the appropriate locations. The appropriate locations for the logos are, for example, those approved by the logo's merchant as embodied in the previously described restricted areas.

The system may be resident on machines distributed for use by merchants or directly by customers, for example in shopping malls, at customer service areas at merchant locations and in free-standing machines such as kiosks. This system may also be resident on machines at plastic card manufacturing, personalization, fulfillment or distribution centers. In these instances, images may be provided by individuals such as clients and customers, or by corporate or organizational clients. Single customized plastic card orders may contain:
one image, object, or photo with accompanying text;
one image, object, or photo without accompanying text;
multiple images, objects or photos per plastic card ordered with accompanying text;
multiple images, objects or photos per plastic card ordered without accompanying text;
text only

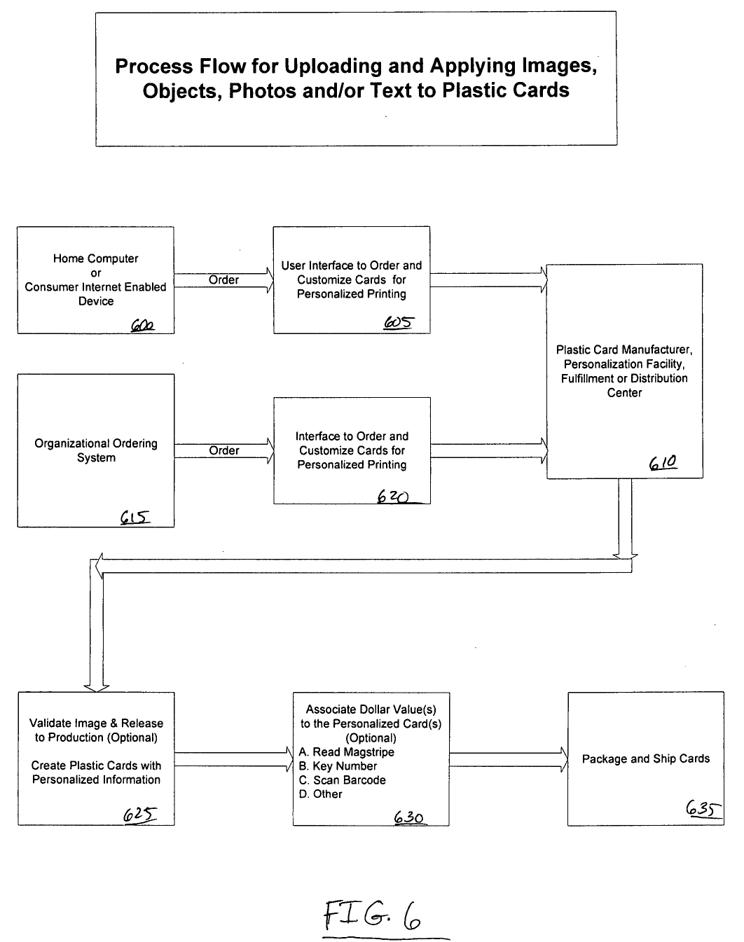

FIG. 6 is a flow chart of a process for uploading and applying images, objects, photos, and/or text to plastic cards according to an embodiment of the present invention. For example, according to the embodiment of FIG. 6, a home user may utilize a home computer or other consumer Internet-enabled device (Step 600). The user may select, customize and order cards for personalized printing (Step 605). Similarly, various organizations may utilize the Internet or other similar connection to order cards (Step 615). The organizations connect to an order interface to select, customize and order cards for personalized printing (Step 620). The order is processed by an order fulfillment facility, which may include a plastic card manufacturer, a personalization facility, a fulfillment or a distribution center (Step 610).

The order fulfillment facility can optionally validate the customized images. The plastic cards are then created with the personalized information (Step 625). Next, the card is associated with a specific dollar amount via the magnetic strip, a key number and/or a barcode (Step 630). The card(s) are then packaged and shipped to the purchaser or to a recipient designated by the purchaser (Step 635).

This embodiment allows a user to purchase multiple cards online, with each card having a different customization. The order can then be shipped to, for example, a recipient, and the cards may each have a different customization and may be of a different type or for a different store or purchase program. Additionally, the order may contain one or more cards and the order may be combined with other goods and shipped in a single order.

Thus, the present invention includes various embodiments, including customization of an already purchased card, and the outright purchase of a card that is then both customized with user preferences and selected participating merchant logos where the card can be used.

Of the various embodiments, the invention includes, but is not limited to a system that accepts a credit card, debit card, ID card, stored value card, gift card, pre-paid card, phone card or other plastic or PVC card and allows a user to apply text or images to the plastic. The card may either be embossed or not embossed. The printer utilized is a high resolution device capable of permanently printing on either embossed or non-embossed cards.

Another embodiment includes a system that allows a user to apply text or images to a credit card, debit card, ID card, stored value card, gift card, pre-paid card, phone card or other plastic or PVC card that is dispensed from a kiosk. As before, the card may either be embossed or not embossed. The printer utilized is a high resolution device capable of permanently printing on either embossed or non-embossed cards.

The present invention may include where direct payment or a code is entered to prior to allowing the system to function. As described above, a display monitor is incorporated and user can view images or pre-defined text to be applied to the card.

In one embodiment, the user can type a text message using a touch screen keyboard or manual keyboard to craft a custom message. The user can view the placement of and the actual text being typed as it is entered. The user may change font, color, and size as well as edit the text and view said changes on the display.

Although the present invention has been described herein with reference to kiosk implementations, similar processes and procedures with an order, card design, and payment mechanism more suitable for utilization on web sites may be incorporated. In this instance, cards are designed and paid for by the user but are processed, packaged and mailed to a consumer as conveyed by the user in the order process. The consumer may or may not be the person ordering the cards.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing a kiosk, any other equivalent device, such as a teller machine, or other device having an equivalent function or capability, whether or not listed herein, may be substituted therewith. Furthermore, the inventors recognize that newly developed technologies not now known may also be substituted for the described parts and still not depart from the scope of the present invention. All other described items, including, but not limited to databases, card readers/writers, payment devices, dispensers, hoppers, interface connections and user interfaces, etc should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CDRW+/−, micro-drive, and magneto-optical disks, ROMs, RAMs, EPROMs, EEPROMs, DRAMs, VRAMs, flash memory devices (including flash cards, memory sticks), magnetic or optical cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, retrieving and placing graphics, assisting in the placement of graphics, selection and retrieval of company/retailer logos, placement of one multiple logos at predefined locations on the card and identifying user selectable space for inclusion of user graphics based on the selected logos, communicating between devices, and the display, storage, printing, or communication of results according to the processes of the present invention.

The present invention may suitably comprise, consist of, or consist essentially of, any of element (the various parts or features of the invention) and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of claims as presented in a later filed utility patent application, upon issuance, that the invention may be practiced otherwise than as specifically described herein.

What is claimed is:

1. An apparatus for customizing and dispensing payment cards, the apparatus comprising:
a user interface including a display;
a printer;
a microprocessor; and
a control program, wherein the microprocessor executes instructions from the control program to provide a custom design for a payment card as selected by a user via the user interface, and to instruct the printer to print the custom design on the payment card.

2. The apparatus of claim 1, wherein the apparatus further comprises a logo card insert to accept a blank card from the user in order to customize the blank card.

3. The apparatus of claim 2, further comprising a scanner to scan the blank card from the user to determine printable areas.

4. The apparatus of claim 2, wherein the apparatus further comprises a card hopper for storing blank cards.

5. The apparatus of claim 1, further comprising a database of customization graphics.

6. The apparatus of claim 5, wherein the customization graphics include text and images.

7. The apparatus of claim 1, wherein the apparatus further comprises a data reading unit to read data provided by a user, wherein the user data is displayed on the display for selection by the user.

8. The apparatus of claim 1, wherein the control program restricts the location of selectable custom design items for printing on the payment card.

9. A method for applying custom graphics to a stored value card dispensed from a kiosk, the method comprising:
receiving a selection of a type of card to be personalized;
displaying an image of a selected card on a display screen, wherein the image includes areas available for insertion of graphics;
receiving a selection of at least one desired available area;
displaying available graphics;
receiving a selection of at least one available graphic for printing in the at least one available area;
printing the selected graphics onto a stored value card; and
dispensing the stored value card.

10. A method for applying graphics to a user's stored value card, the method comprising:
receiving a stored value card to be printed;
providing a selection of card categories;
providing a selection of cards from a selected card category;
displaying a selected card with a highlighted printable areas;
receiving a selection of an area for printing;
receiving a selection of a desired graphic for printing in the selected printable area;
printing the selected graphics in the selected printable area on the stored value card; and
dispensing the stored value card.

11. A method for providing customized payment cards, the method comprising:
receiving a selection of a type of card to be personalized;
displaying an image of a selected card on a display screen, wherein the image includes areas available for insertion of graphics;
receiving a selection of at least one desired available area;
displaying available graphics;
receiving a selection of at least one available graphic for printing in the at least one available area;
printing the selected graphics onto a payment card; and
associating a dollar value with the payment card.

12. The method of claim 11, wherein the step of displaying available graphics comprises receiving a desired graphic from a purchaser and displaying the graphic on the display.

13. The method of claim 11, wherein the receiving a selection steps are performed via the Internet, and the card is shipped to a recipient designated by a purchaser.

14. The method of claim 13, wherein the purchaser selects multiple cards, and wherein each card can be individually customized.

15. The method of claim 13, wherein the card is combined with other goods purchased and shipped in a single order.
